(19) United States
(12) Patent Application Publication
(10) Pub. No.: US 2025/0185842 A1
(43) Pub. Date: Jun. 12, 2025

(54) WATER SUPPLY DEVICE FOR A COFFEE MACHINE

(71) Applicant: Wuxi Huozhong Power Equipment Co., Ltd, Wuxi (CN)

(72) Inventor: Liang CHEN, Wuxi (CN)

(73) Assignee: Wuxi Huozhong Power Equipment Co., Ltd, Wuxi, JS (CN)

(21) Appl. No.: 18/950,207

(22) Filed: Nov. 18, 2024

(30) Foreign Application Priority Data
Dec. 11, 2023 (CN) 202311690900.9

(51) Int. Cl. A47J 31/54; A47J 31/46

(52) U.S. Cl. CPC A47J 31/545; A47J 31/461

(57) ABSTRACT

The present invention discloses a water supply device for a coffee machine, comprising: a heating block housing a hot water pipeline; a water flow channel system adjacent to the heating block, including an inlet valve, an outlet valve, and a chamber, wherein both valves are one-way and communicate with the chamber—the inlet valve connected to a water inlet and the outlet valve to the hot water pipeline; a camshaft positioned beside the heating block; an elliptical annular guide rail encircling the camshaft longitudinally, with the maximum diameter ends located at both longitudinal ends of the camshaft; two sliders moving along the guide rail; two piston assemblies, each connected at one end to a slider and at the other end to a chamber; two chambers corresponding to the piston assemblies; as the camshaft rotates, the two piston heads alternately drive water into and out of their respective chambers.

### TECHNICAL FIELD

The present invention relates to the technical field of coffee machines, specifically to a water supply device for a coffee machine.

### BACKGROUND TECHNOLOGY

Existing water supply devices for extracting coffee liquid cannot control the flow rate and velocity of the water pathway. They are directly connected to external hot water pipelines, and the flow rate and velocity of the water inside the hot water pipeline are directly manifested through the extraction head during coffee extraction. Because the flow rate and velocity of the water are uncontrollable, it is impossible to regulate the amount of water used in coffee extraction liquid. In particular, it is impossible to ensure a uniform and uninterrupted flow of water inside the hot water pipeline, which affects the effectiveness of coffee extraction. Poor extraction results can severely impact the taste of the coffee liquid.

How to solve the above technical problems has become an urgent technical challenge in the industry.

### SUMMARY OF THE INVENTION

To at least solve the above technical problems, the objective of the present invention is to provide a water supply device for a coffee machine, achieving controllable hot water during coffee extraction.

To achieve the above objective, the water supply device for a coffee machine provided by the present invention includes: a heating block; a hot water pipeline arranged within the heating block; a water flow channel system set on the side of the heating block, the water flow channel system including two water flow channels; each water flow channel includes an inlet valve, an outlet valve, and a chamber; the inlet valve and the outlet valve both communicate with the chamber; the inlet valve and the outlet valve are both one-way valves; the outlet valve communicates with the hot water pipeline; the inlet valve communicates with a water inlet; a camshaft arranged on the side of the heating block; an elliptical annular guide rail encircling the camshaft along its longitudinal direction; the two ends of the maximum diameter of the annular guide rail are located at both ends along the longitudinal direction of the camshaft; sliders arranged within the annular guide rail, moving along the annular guide rail; a piston assembly, one end connected to the slider and the other end connected to the chamber; there are two sliders; there are two piston assemblies; there are two chambers; the two sliders are symmetrically distributed on both sides of the camshaft; the piston assembly includes: a piston, which includes a piston head and a piston rod; one end of the piston rod is fixedly connected to the piston head, and the other end of the piston rod is connected to the slider; when the camshaft rotates, the two piston heads alternately perform work within their corresponding chambers.

Further, the piston assembly further includes: a fixed block and a fixed rod; one side of the fixed block is fixedly connected to the slider; the other end of the piston rod passes through the fixed block to connect with the slider; one end of the fixed rod is fixedly connected to the heating block; the fixed block is sleeved over the fixed rod; the fixed block moves along the longitudinal direction of the fixed rod.

Further, the hot water pipeline is arranged in a continuous S-shape within the heating block.

Further, the heating block further includes: heating rods evenly distributed around the hot water pipeline.

Further, the hot water pipeline is provided with a water outlet; the water outlet is arranged outside the body of the heating block; a pressure sensor is provided at the water outlet.

Further, the device also includes: a driving motor used to drive the camshaft to rotate; the camshaft is cylindrical, and one end of the cylindrical camshaft is provided with a transmission wheel; the driving motor drives the camshaft through the transmission wheel.

Further, the device includes: a driving module configured to control the operating frequency of the driving motor.

In an embodiment of the present application, the coffee machine's water supply device comprises: a heating block; a hot water pipeline disposed within the heating block; a water flow channel system arranged on the side of the heating block; the water flow channel system includes two water flow channels; each water flow channel comprises an inlet valve, an outlet valve, and a chamber; the inlet valve and the outlet valve both communicate with the chamber; the inlet valve and the outlet valve are both one-way valves; the outlet valve communicates with the hot water pipeline; the inlet valve communicates with a water inlet; a camshaft disposed on the side of the heating block; an elliptical annular guide rail encircles the camshaft along its depth direction; both ends of the maximum diameter of the annular guide rail are located at the two ends along the camshaft's depth direction; sliders arranged within the annular guide rail, moving along it; there are two sliders; piston assemblies, each connected at one end to a slider and at the other end to a chamber; there are two piston assemblies; there are two chambers; the two sliders are symmetrically distributed on both sides of the camshaft; each piston assembly includes: a piston comprising a piston head and a piston rod; one end of the piston rod is fixedly connected to the piston head; the other end of the piston rod is connected to the slider; when the camshaft rotates, the two piston heads alternately perform work within their corresponding chambers. Through the cooperation of the pistons and the water flow channels, controllable water flow within the hot water pipeline is achieved. The alternating cooperation of the dual pistons and dual chambers makes the water supply within the hot water pipeline more uniform and stable, thereby ensuring the uniformity and stability of hot water during coffee extraction. The continuous S-shaped configuration of the hot water pipeline within the heating block, along with the uniform distribution of heating rods around the hot water pipeline, results in more uniform and stable water temperature, higher heating efficiency, and controllable temperature. This greatly ensures the water temperature requirements during coffee extraction, guarantees the taste of the coffee liquid, and enhances market competitiveness.

### BRIEF DESCRIPTION OF THE DRAWINGS

The drawings are provided to offer further understanding of the present application and constitute a part of the specification. They are used to explain the present application together with the embodiments and do not limit the scope of the application. In the drawings:

FIG. 1 is a schematic structural diagram of the water supply device for a coffee machine according to an embodiment of the present application;

FIG. 2 is a schematic structural diagram of the camshaft according to an embodiment of the present application;

FIG. 3 is a cross-sectional schematic diagram showing the structure when the water flow channel assembly matches with the water valve group according to an embodiment of the present application.

Reference Numerals: 101—Heating block; 102—Heating rod; 103—Water flow channel assembly; 104—Water valve group; 105—Camshaft; 106—Second piston; 107—First piston; 108—Driving motor; 109—Driving module; 201—Fixed block; 202—Slider; 203—Annular guide rail; 204—Fixed rod; 301—Water inlet; 302—First outlet valve; 303—First inlet valve; 304—Second inlet valve; 305—Second outlet valve; 306—First chamber; 307—Second chamber; 308—Pressure sensor; 309—Water outlet.

### DETAILED DESCRIPTION

Below, the embodiments of the present application will be described in more detail with reference to the accompanying drawings. Although certain embodiments of the present application are shown in the drawings, it should be understood that the present application can be implemented in various forms and should not be construed as limited to the embodiments set forth herein. Rather, these embodiments are provided to make the present application more thorough and complete, and to fully convey the scope of the application to those skilled in the art. It should be understood that the accompanying drawings and embodiments are provided for illustrative purposes only and are not intended to limit the scope of protection of the present application.

It should be understood that the various steps described in the method embodiments of the present application can be performed in different orders and/or executed concurrently. In addition, the method embodiments may include additional steps and/or omit the execution of certain steps shown. The scope of the present application is not limited in this regard.

The term “comprising” and its variations as used herein are open-ended terms, meaning “including but not limited to.” The term “based on” means “at least partially based on.” The term “an embodiment” means “at least one embodiment”; the term “another embodiment” means “at least one other embodiment”; the term “some embodiments” means “at least some embodiments.” Relevant definitions of other terms will be provided in the descriptions below.

It should be noted that the modifiers “a,” “an,” and “multiple” mentioned in this application are illustrative and not limiting. Those skilled in the art should understand that unless explicitly stated otherwise in context, they should be understood as “one or more.” “Multiple” should be understood as two or more.

Below, the embodiments of the present application will be described in detail with reference to the accompanying drawings.

The water supply device for a coffee machine provided by the embodiments of the present invention includes: a heating block; a hot water pipeline, which is arranged within the heating block; a water flow channel system set on the side of the heating block; the water flow channel system includes two water flow channels; the water flow channels include an inlet valve, an outlet valve, and a chamber; the inlet valve and the outlet valve both communicate with the chamber; the inlet valve and the outlet valve are both one-way valves; the outlet valve communicates with the hot water pipeline; the inlet valve communicates with a water inlet; a camshaft, arranged on the side of the heating block; along the longitudinal direction of the camshaft, an elliptical annular guide rail encircles it; the two ends of the maximum diameter of the annular guide rail are located at both ends along the longitudinal direction of the camshaft; a slider, set within the annular guide rail, which moves along the annular guide rail; a piston assembly, one end of which is connected to the slider, and the other end is connected to the chamber; the sliders include two sliders; the piston assemblies include two piston assemblies; the chambers include two chambers; the two sliders are symmetrically distributed on both sides of the camshaft; the piston assembly includes: a piston, which includes a piston head and a piston rod; one end of the piston rod is fixedly connected to the piston head, and the other end of the piston rod is connected to the slider; when the camshaft rotates, the two piston heads alternately drive water into and out of their corresponding chambers.

### Embodiment 1

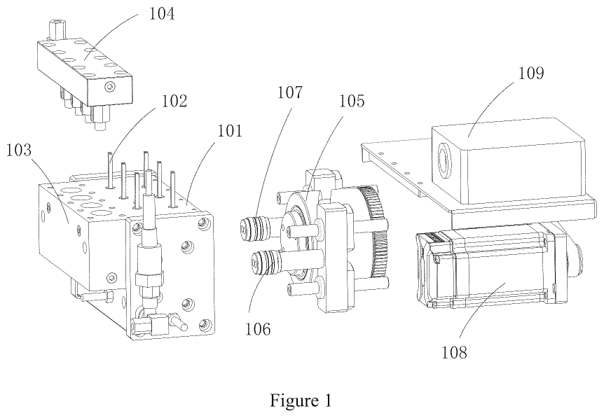

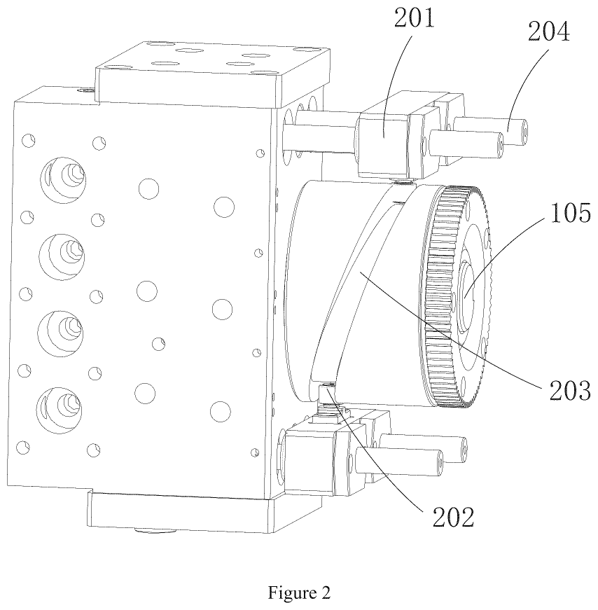

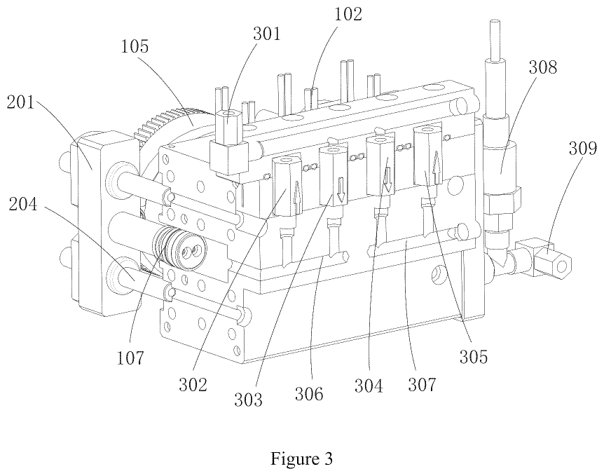

FIG. 1 is a schematic structural diagram of the water supply device for a coffee machine according to an embodiment of the present application; FIG. 2 is a schematic structural diagram of the camshaft according to an embodiment of the present application; FIG. 3 is a cross-sectional schematic diagram showing the structure when the water flow channel assembly matches with the water valve group according to an embodiment of the present application. Below, with reference to FIGS. 1-3, a detailed description of the water supply device for a coffee machine according to the embodiment of the present invention is provided.

In an exemplary embodiment, the water supply device for a coffee machine according to the embodiment of the present application is used to provide hot water to a coffee machine.

In an exemplary embodiment, the water supply device is externally connected to a coffee liquid extraction device; for example, the water outlet 309 communicates with the extraction head of the coffee machine.

In an exemplary embodiment, the water supply device includes: heating block 101.

In an exemplary embodiment, the heating block 101 is used to heat the cold water or warm water flowing through it to the temperature required for extracting coffee liquid, for example, heating it to 90° C.-94° C.

In an exemplary embodiment, the heating block 101 is provided with multiple counterbores, which are used for placing heating rods 102.

In an exemplary embodiment, the device further includes: hot water pipeline.

In an exemplary embodiment, the hot water pipeline is arranged within the heating block 101; it can be understood that the hot water pipeline passes through the heating block 101, and the heating block heats the water within the pipeline.

In an exemplary embodiment, the hot water pipeline is arranged in a continuous S-shape within the heating block 101; that is, the shape of the hot water pipeline inside the heating block 101 is a continuous S-shape.

In an exemplary embodiment, the heating rods 102 are evenly distributed around the hot water pipeline.

In an exemplary embodiment, there are multiple heating rods 102, which are evenly distributed on the heating block 101.

In an exemplary embodiment, the even distribution of multiple heating rods 102 around the hot water pipeline ensures uniform heating of the hot water and allows for continuous hot water supply.

In an exemplary embodiment, the device further includes: water flow channel system.

In an exemplary embodiment, the water flow channel system includes multiple water flow channels.

In an exemplary embodiment, the water flow channel system includes two water flow channels.

In an exemplary embodiment, each water flow channel includes an inlet valve, an outlet valve, and a chamber; that is, the water flow channel system is composed of multiple water flow channels, each comprising an inlet valve, an outlet valve, and a chamber.

In an exemplary embodiment, optionally, the water flow channel system includes a water flow channel assembly 103 and a water valve group 104.

In an exemplary embodiment, the water flow channel assembly 103 is arranged on the side of the heating block 101.

In an exemplary embodiment, the water valve group 104 is arranged on the water flow channel assembly 103.

In an exemplary embodiment, the water flow channel assembly 103 includes the aforementioned chambers.

In an exemplary embodiment, the water valve group 104 includes the aforementioned inlet valves and outlet valves.

In an exemplary embodiment, the inlet valves and outlet valves are all installed on the chambers; that is, the inlet and outlet valves on the water valve group 104 all communicate with the chambers on the water flow channel assembly 103.

In an exemplary embodiment, in each water flow channel, water enters through the inlet valve, passes through the chamber, and then flows out through the outlet valve into the hot water pipeline.

In an exemplary embodiment, the inlet valves and outlet valves are all one-way valves; that is, the inlet valves allow water to enter in one direction only, and the outlet valves allow water to exit in one direction only.

In an exemplary embodiment, the outlet valves communicate with the hot water pipeline; that is, the water in the water flow channels ultimately enters the hot water pipeline through the outlet valves, and then is heated by the heating block 101 to reach the temperature required for coffee extraction.

In an exemplary embodiment, optionally, the water valve group 104 is provided with a water inlet 301.

In an exemplary embodiment, the inlet valves communicate with the water inlet 301; that is, the water in the water flow channels is drawn from the water inlet 301. When there are multiple water flow channels, the water inlet 301 communicates with multiple inlet valves respectively.

In an exemplary embodiment, the coffee machine water supply device of this embodiment further includes: a camshaft 105.

In an exemplary embodiment, the camshaft 105 is arranged on the side of the heating block 101.

In an exemplary embodiment, optionally, the camshaft 105 and the water flow channel assembly 103 are arranged on opposite sides of the heating block 101.

In an exemplary embodiment, along the longitudinal direction of the camshaft 105, there is an elliptical annular guide rail 203 encircling it.

In an exemplary embodiment, the camshaft 105 is cylindrical or similar to cylindrical.

In an exemplary embodiment, one end of the camshaft 105 is provided with a transmission wheel, and the other end is not provided with a transmission wheel.

In an exemplary embodiment, optionally, the transmission wheel on the camshaft 105 can be a gear.

In an exemplary embodiment, the two ends of the maximum diameter of the annular guide rail 203 are located at both ends along the longitudinal direction of the camshaft 105; that is, the two ends of the maximum diameter of the elliptical annular guide rail 203 are respectively near the end of the camshaft 105 with the transmission gear and the opposite end corresponding to the transmission gear.

In an exemplary embodiment, the coffee machine water supply device of this embodiment further includes: sliders 202.

In an exemplary embodiment, the sliders 202 are set within the elliptical annular guide rail.

In an exemplary embodiment, optionally, the sliders 202 are embedded within the elliptical annular guide rail 203.

In an exemplary embodiment, the sliders 202 can move along the annular guide rail 203; that is, the sliders 202 can move continuously within the elliptical annular guide rail 203 along its path.

In an exemplary embodiment, there are multiple sliders 202, for example, two.

In an exemplary embodiment, the two sliders 202 are symmetrically distributed on both sides of the camshaft 105.

In an exemplary embodiment, the number of sliders 202 is the same as the number of water flow channels; it can be understood that one slider 202 corresponds to one water flow channel.

In an exemplary embodiment, the coffee machine water supply device of this embodiment further includes: piston assemblies.

In an exemplary embodiment, one end of each piston assembly is connected to the slider 202, and the other end is connected to the chamber.

In an exemplary embodiment, there are multiple piston assemblies, for example, two.

In an exemplary embodiment, the number of piston assemblies is the same as the number of sliders 202.

In an exemplary embodiment, the number of piston assemblies is the same as the number of chambers.

In an exemplary embodiment, when the camshaft 105 rotates, the sliders 202 drive the piston assemblies to move, and the piston assemblies then drive the water in the chambers to flow in and out. When there are two sliders 202, they are arranged on both sides of the camshaft 105. Due to the cooperation between the sliders 202 and the elliptical annular guide rail 203, the two piston assemblies alternately drive the water in the chambers to flow in and out.

In an exemplary embodiment, each piston assembly includes a piston.

In an exemplary embodiment, the piston includes a piston head and a piston rod.

In an exemplary embodiment, one end of the piston rod is fixedly connected to the piston head.

In an exemplary embodiment, the other end of the piston rod is connected to the slider 202; depending on the needs, the other end of the piston rod can be directly connected to the slider 202 or indirectly connected through a third party. The connection method can be fixed or movable.

In an exemplary embodiment, when the other end of the piston rod is indirectly connected to the slider 202 through a third party, the piston assembly further includes: a fixed block 201; that is, the other end of the piston rod is connected to the slider 202 through the fixed block 201.

In an exemplary embodiment, one side of the fixed block 201 is fixedly connected to the slider 202; the other end of the piston rod passes through the fixed block 201 to connect with the slider 202.

In an exemplary embodiment, there are two piston assemblies.

In an exemplary embodiment, there are two water flow channels.

In an exemplary embodiment, there are two chambers.

In an exemplary embodiment, for example, the water flow channels include a first water flow channel and a second water flow channel.

In an exemplary embodiment, the first water flow channel includes a first inlet valve 303, a first chamber 306, and a first outlet valve 302.

In an exemplary embodiment, the second water flow channel includes a second inlet valve 304, a second chamber 307, and a second outlet valve 305.

In an exemplary embodiment, the piston assembly further includes: fixed rods 204.

In an exemplary embodiment, there are multiple fixed rods 204; for example, each fixed block 201 is equipped with two fixed rods 204.

In an exemplary embodiment, multiple fixed rods 204 are arranged in parallel.

In an exemplary embodiment, one end of each fixed rod 204 is fixedly connected to the heating block 101.

In an exemplary embodiment, the fixed block 201 is movably sleeved on the fixed rod 204.

In an exemplary embodiment, the fixed block 201 reciprocates along the longitudinal direction of the fixed rod 204.

In an exemplary embodiment, when the camshaft 105 rotates, it drives two sliders 202 on both sides to move along the annular guide rail 203. The sliders 202, in turn, drive the pistons to move within the chambers, thereby achieving alternate entry and exit of the pistons on both sides into their corresponding chambers. This results in the two water flow channels alternately supplying water to the hot water pipeline.

In an exemplary embodiment, the heating block 101 further includes piston bores that match the pistons, and these piston bores communicate with the chambers.

In an exemplary embodiment, the piston bores match the pistons.

In an exemplary embodiment, the two piston assemblies are symmetrically arranged on both sides of the camshaft 105, and the two piston assemblies are respectively provided with a first piston 107 and a second piston 106.

In an exemplary embodiment, the first inlet valve 303 and the second inlet valve 304 both communicate with the water inlet 301.

In an exemplary embodiment, the first outlet valve 302 and the second outlet valve 305 both communicate with the hot water pipeline.

In an exemplary embodiment, the first chamber 306 and the second chamber 307 are not connected to each other.

In an exemplary embodiment, when the camshaft 105 rotates, the two piston heads alternately drive water into and out of their respective chambers.

In an exemplary embodiment, as the camshaft 105 rotates, the slider 202 corresponding to the first piston 107 moves within the annular guide rail 203 from the nearest point relative to the heating block 101 to the farthest point—that is, when the first piston 107 moves away from the first chamber 306. The first chamber 306 forms a negative pressure, the first inlet valve 303 opens to allow water in, and the first outlet valve 302 is closed. Simultaneously, the slider 202 corresponding to the second piston 106 moves within the annular guide rail 203 from the farthest point relative to the heating block 101 to the nearest point—that is, when the second piston 106 compresses into the second chamber 307. The second chamber 307 is in a compressed state, the second inlet valve 304 closes, and the second outlet valve 305 opens. At this time, the first chamber 306 is taking in water, and the second chamber 307 is discharging water.

In an exemplary embodiment, as the camshaft 105 continues to rotate, the slider 202 corresponding to the first piston 107 moves within the annular guide rail 203 from the farthest point relative to the heating block 101 to the nearest point—that is, when the first piston 107 compresses into the first chamber 306. The first chamber 306 is in a compressed state, the first inlet valve 303 closes, and the first outlet valve 302 opens. Simultaneously, the slider 202 corresponding to the second piston 106 moves within the annular guide rail 203 from the nearest point relative to the heating block 101 to the farthest point—that is, when the second piston 106 moves away from the second chamber 307. The second chamber 307 forms a negative pressure, the second inlet valve 304 opens, and the second outlet valve 305 closes. At this time, the first chamber 306 is discharging water, and the second chamber 307 is taking in water.

In an exemplary embodiment, through the alternate intake and discharge of water in the first chamber 306 and the second chamber 307, uninterrupted water supply to the hot water pipeline is achieved. When the camshaft 105 rotates at a constant speed, it better ensures uninterrupted and uniform water supply in the hot water pipeline, thereby enhancing the effectiveness of coffee liquid extraction. Furthermore, it realizes uniform and controllable flow rate of hot water in the hot water pipeline, allowing stepless adjustment of the hot water flow rate.

In an exemplary embodiment, the coffee machine water supply device of this application further includes: a water outlet 309.

In an exemplary embodiment, the water outlet 309 is the outlet of the hot water pipeline—that is, the water outlet 309 communicates with the hot water pipeline. It can be understood that the water heated by the heating block 101 in the hot water pipeline flows out through the water outlet 309 and is then used for coffee liquid extraction.

In an exemplary embodiment, the water outlet 309 is arranged outside the body of the heating block 101.

In an exemplary embodiment, a pressure sensor 308 is provided at the water outlet 309, which is used to detect the pressure of the hot water in the hot water pipeline.

In an exemplary embodiment, optionally, the hot water pipeline inside the heating block 101 passes through the pressure sensor 308 before flowing out from the water outlet 309.

In an exemplary embodiment, the coffee machine water supply device of this application further includes: a driving motor 108.

In an exemplary embodiment, the driving motor 108 is used to drive the camshaft 105 to rotate.

In an exemplary embodiment, the driving motor 108 drives the camshaft 105 through a transmission gear at one end of the camshaft 105. Of course, as needed, an intermediate transmission gear component may also be included between the driving motor 108 and the transmission gear—that is, the driving motor 108 drives the camshaft 105 through the intermediate transmission gear component.

In an exemplary embodiment, the coffee machine water supply device of this application further includes: a driving module 109.

In an exemplary embodiment, the driving module 109 is used to control the operating frequency of the driving motor 108.

In an exemplary embodiment, by adjusting the rotational frequency of the driving motor 108, the water flow rate and velocity within the hot water pipeline can be adjusted.

In an exemplary embodiment, the coffee machine water supply device of this application further includes: a heating rod 102 control module.

In an exemplary embodiment, the heating rod 102 control module is used to control the output power of the heating rod 102, thereby adjusting the water temperature of the hot water pipeline flowing through the heating block 101.

In an exemplary embodiment, optionally, the water inlet 301 receives water from an external water source, which can be cold water or warm water.

In an exemplary embodiment, optionally, the water inlet 301 is externally connected to a water storage tank, which can preheat the water, thereby ensuring that the water heated by the heating block meets the temperature requirements for extraction.

Although the embodiments of the present invention are disclosed above, the content is only the embodiments adopted to facilitate understanding of the present invention and is not intended to limit the present invention. Any technician in the field of the present invention, without departing from the spirit and scope disclosed by the present invention, can make any modifications and changes in the form and details of implementation. However, the scope of patent protection of the present invention shall still be subject to the scope defined by the appended claims.

What is claimed is:

1. A water supply device for a coffee machine, characterized by comprising: a heating block; a hot water pipeline arranged within the heating block; a water flow channel system provided on a side of the heating block, the water flow channel system including two water flow channels; each of the water flow channels includes an inlet valve, an outlet valve, and a chamber; the inlet valve and the outlet valve both communicate with the chamber and are both one-way valves; the outlet valve communicates with the hot water pipeline; the inlet valve communicates with a water inlet; a camshaft arranged on the side of the heating block; an elliptical annular guide rail encircling the camshaft along its longitudinal direction, with the two ends of the maximum diameter of the annular guide rail located at both ends along the longitudinal direction of the camshaft; sliders disposed within the annular guide rail, moving along the annular guide rail; piston assemblies, each having one end connected to a slider and the other end connected to the chamber; the sliders include two sliders; the piston assemblies include two piston assemblies; the chambers include two chambers; the two sliders are symmetrically distributed on both sides of the camshaft; each piston assembly includes: a piston, which includes a piston head and a piston rod; one end of the piston rod is fixedly connected to the piston head, and the other end of the piston rod is connected to the slider; when the camshaft rotates, the two piston heads alternately drive water into and out of their respective chambers.

2. The water supply device for a coffee machine according to claim 1, wherein the piston assemblies further comprise: a fixed block and a fixed rod; one side of the fixed block is fixedly connected to the slider; the other end of the piston rod passes through the fixed block and connects to the slider; one end of the fixed rod is fixedly connected to the heating block; the fixed block is sleeved over the fixed rod; the fixed block moves along the longitudinal direction of the fixed rod.

3. The water supply device for a coffee machine according to claim 2, wherein the hot water pipeline is arranged in a continuous S-shape within the heating block.

4. The water supply device for a coffee machine according to claim 3, wherein the heating block further comprises: heating rods evenly distributed around the hot water pipeline.

5. The water supply device for a coffee machine according to claim 4, wherein: the hot water pipeline is provided with a water outlet; the water outlet is arranged outside the body of the heating block; a pressure sensor is provided at the water outlet.

6. The water supply device for a coffee machine according to claim 5, further comprising: a driving motor used to drive the camshaft to rotate; the camshaft is cylindrical, and one end of the cylindrical camshaft is provided with a transmission wheel; the driving motor drives the camshaft through the transmission wheel.

7. The water supply device for a coffee machine according to claim 6, further comprising: a driving module configured to control the operating frequency of the driving motor.
